(19) United States
(12) Patent Application Publication
(10) Pub. No.: US 2014/0278098 A1
(43) Pub. Date: Sep. 18, 2014

(54) Display Control Device, Display Control Method, and Tangible Non-Transitory Computer-Readable Storage Medium

(71) Applicants: Toyota Jidosha Kabushiki Kaisha, Toyota-shi (JP); Toyota Mapmaster Incorporated, Nagoya-shi (JP)

(72) Inventors: Kenji Kunimatsu, Nagoya-shi (JP); Yumiko Yamashita, Nagoya-shi (JP); Kuniaki Tanaka, Toyota-shi (JP); Tomoki Kodan, Toyota-shi (JP); Tomoo Nomura, Kariya-shi (JP); Naoto Miura, Anjo-shi (JP); Shingo Kato, Anjo-shi (JP); Atsushi Osaki, Anjo-shi (JP); Hiroki Kawai, Anjo-shi (JP)

(73) Assignees: Toyota Jidosha Kabushiki Kaisha, Toyota-sh (JP); Toyota Mapmaster Incorporated, Nagoya-shi (JP)

(21) Appl. No.: 14/196,263

(22) Filed: Mar. 4, 2014

(30) Foreign Application Priority Data
Mar. 15, 2013 (JP) 2013-052624

(51) Int. Cl. G01C 21/00

(52) U.S. Cl. CPC G01C 21/00
USPC 701/533

(57) ABSTRACT

A display control method for displaying an alternative position different from a position of a destination when the position of the destination is unable to be displayed at a specific point in a center of a map as a result of a destination search, acquires, when the alternative position is displayed, a position indication item, which is to be displayed on the map, together with point coordinates, which are associated with the position indication item, from a detailed display database storing the position indication item and the associated point coordinates, and displays the acquired position indication item on the map based on the associated point coordinates.

### FIELD OF INVENTION

The present invention relates to a display control device and a display control method for displaying an alternative position of a destination that is different from the position of the destination when the position of the destination is not displayed at a specific point in the center of a map in a destination search.

### BACKGROUND ART

In general, during destination searches by navigation devices, when the position of the destination is not displayed in the center of the map at a specific point (such as when the search database for the destination search does not include the destination that matches the inputted destination), a position, which substitutes the position of the destination and which is different from the destination, is alternatively displayed in the center of the map as a temporal destination or a temporal arrival point. In other words, a peripheral position of the above destination is alternatively displayed in the center of the map as a representative position.

As above, when the position different from the destination is displayed in the center of the map as the temporal destination, the user of the above navigation device, in general, visually searches for the true destination on the map displayed on the screen, and then adjusts the map, when necessary, to have the true destination displayed in the center of the map in order to set the true destination. However, there is limited information on house numbers and facility names displayed on the map and thereby the user has difficulty setting the true destination.

In order to deal with the above problem, Patent Document 1 discloses a technique, where a navigation device displays potential house numbers in a list of potential house numbers as a technique for displaying a house number that partially matches part of the house number as a potential house number when a house number inputted as the destination does not exist in a search list of house numbers.

Please refer to Patent Documents 2 to 5 that disclose conventional techniques related to the present invention.

### PRIOR ART REFERENCE

### Patent Document

Patent Document 1: JP-A-2002-202142

Patent Document 2: JP-A-H8-14930

Patent Document 3: JP-A-2008-52077

Patent Document 4: JP-A-H7-103785

Patent Document 5: JP-A-2008-82868

### SUMMARY OF THE INVENTION

### Problems to be Solved by the Invention

In Patent Document 1, although a list of the potential house numbers are displayed, it is difficult to immediately recognize a relation between the potential house numbers and positions thereof on the map, and thereby there is a need for further improvement.

The present inventors have diligently studied in order to solve the above problem. As a result, the inventors have contemplated that it is easy to recognize the position relation of the position indication item (such as the house number, the facility name) on the map when the position indication item is displayed based on the point coordinates associated with the position indication item.

### Means for Solving the Problems

The invention is made in view of the above problem, and the first aspect is defined as follows. More specifically,

a display control device for displaying an alternative position different from a position of a destination when the position of the destination is unable to be displayed at a specific point in a center of a map as a result of a destination search, includes:

a detailed display database storing a position indication item and point coordinates associated with the position indication item;

a data acquisition unit configured to acquire the position indication item, which is to be displayed on the map, together with the associated point coordinates when the alternative position is displayed; and

a display control unit configured to display the acquired position indication item on the map based on the associated point coordinates.

According to the display control device of the first aspect as defined above, in the destination search, when the destination search results in the position of the destination not being displayed at a specific point in the center of the map, the position indication item stored in the detailed display database is displayed on the map in association with the point coordinates. Therefore, the user of the device is capable of easily grasping the position relation of the position indication item on the map when the user sets the true destination.

In the present specification, the detailed display database is a database storing the position indication item and the point coordinates that are associated with the position indication item, and includes data related to the position indication item to be added to a standard mode map, which is hereinafter also referred to as a standard display map and which is displayed by referring to the standard display database. For example, such detailed display database may be provided in addition to the search database and the standard display database. Also, examples of the detailed display database include another map display database that is different from the map display database serving as a basis of the above standard display map. Such database may be, for example, another standard display database more specific than the standard display database serving as the basis of the above standard display map.

Note that, in the above standard display map, some characters are dropped, when necessary, in order to prevent the overlap of the characters indicating the address information and the facility names such that the thus adjusted map provides an easily-grasped view for the user. The position indication item indicates a point on the map, and examples of the position indication item include address information (such as -Chome, house number, and the like), facility names (such as building names, tenant names, and the like), telephone numbers, postal codes, and the like. The address information indicates a certain area on the map, and includes an address area name (such as ward name, city/town name, street name, and the like) in addition to the above address numbers (such as -Chome, house number, and the like). Thus, the address information is the combination of the address area name and the address number.

Usually, when a temporal destination is displayed in the center of a map, the device user sets the true destination by scrolling the map based on an index. The index corresponds to a house number of the destination or a house number of a peripheral location of the destination when the device user inputs the destination address for the search. Also, the index corresponds to a facility name of the destination or a facility name of the peripheral location of the destination when the device user inputs the facility name of the destination for the search.

Thus, the second aspect of the invention is defined as follows. More Specifically, in the display control device defined in the first aspect, the data acquisition unit acquires the position indication item based on an input category of the destination in the destination search.

According to the display control device of the second aspect defined as above, it is possible to display the above position indication item based on an input category of the destination performed by the device user. The above user is conveniently capable of recognizing the position relation of the position indication item on the map based on the input category the user used for the destination search. Specifically, when the address of the destination is inputted as the input category, the data, such as “-Chome”, “house number”, is displayed as the above position indication item, and when the facility name of the destination is inputted, the data such as “building name”, “tenant name”, is displayed as the position indication item.

The third aspect of the invention is defined as follows. More Specifically,

in the display control device defined in the second aspect, the display control unit replaces the position indication item, which is displayed on the standard display map with the input category different from the input category of the destination, with the acquired position indication item when the alternative position is displayed.

According to the display control device of the third aspect as defined above, it is possible to display, on the map, the position indication item that is limited to the input category of the destination provided by the device user. Because the position indication item of the category that is different from the input category of the destination provided by the user is not displayed, the map is capable of providing an easily-grasped view for the above user.

Also, the fourth aspect of the invention is defined as follows. More specifically,

a display control method for displaying an alternative position different from a position of a destination when the position of the destination is unable to be displayed at a specific point in a center of a map as a result of a destination search, includes:

acquiring, when the alternative position is displayed, a position indication item, which is to be displayed on the map, together with point coordinates, which are associated with the position indication item, from a detailed display database storing the position indication item and the associated point coordinates; and

displaying the acquired position indication item on the map based on the associated point coordinates.

According to the invention of the fourth aspect as defined above, it is possible to achieve the effects equivalent to those achieved by the first aspect.

The fifth aspect of the invention is defined as follows. More specifically,

in the method defined in the fourth aspect, the acquiring of the position indication item acquires the position indication item based on an input category of the destination in the destination search.

According to the invention of the fifth aspect as defined above, it is possible to achieve the effects equivalent to those of the second aspect.

The sixth aspect of the invention is defined as follows. More Specifically,

in the method defined in the fifth aspect, the displaying of the acquired position indication item replaces the position indication item, which is displayed on the standard display map with the input category different from the input category of the destination, with the acquired position indication item when the alternative position is displayed.

According to the invention of the sixth aspect as defined above, it is possible to achieve the effects equivalent to those of the third aspect.

Furthermore, the seventh aspect of the invention is defined as follows. More specifically,

a tangible non-transitory computer-readable storage medium contains a computer program for displaying an alternative position different from a position of a destination when the position of the destination is unable to be displayed at a specific point in a center of a map as a result of a destination search, wherein the computer program, when executed by a computer, causes the computer to function as:

data acquiring means for acquiring, when the alternative position is displayed, a position indication item, which is to be displayed on the map, together with point coordinates, which are associated with the position indication item, from a detailed display database storing the position indication item and the associated point coordinates; and

display controlling means for displaying the acquired position indication item on the map based on the associated point coordinates.

According to the invention of the seventh aspect as defined above, it is possible to achieve the effects equivalent to those of the first aspect.

The eighth aspect of the invention is defined as follows. More specifically,

in the storage medium defined in the seventh aspect, the data acquiring means acquires the position indication item based on an input category of the destination in the destination search.

According to the invention of the eighth aspect as defined above, it is possible to achieve the effects equivalent to those of the second aspect.

The ninth aspect of the invention is defined as follows. More specifically,

in the storage medium defined in the eighth aspect, the display controlling means replaces the position indication item, which is displayed on the standard display map with the input category different from the input category of the destination, with the acquired position indication item when the alternative position is displayed.

According to the invention of the ninth aspect as defined above, it is possible to achieve the effects equivalent to those of the third aspect.

### BRIEF DESCRIPTION OF THE DRAWINGS

FIG. 1 is a block diagram illustrating a configuration of a display control device according to an embodiment of the present invention.

FIG. 2 is a flow chart illustrating one example of an operation of the display control device according to the embodiment of the present invention.

FIG. 3 is a block diagram illustrating a configuration of a display control device according to another embodiment of the present invention.

FIG. 4 is a block diagram illustrating a configuration of a display control device of an embodiment example of the present invention.

### EMBODIMENT FOR CARRYING OUT THE INVENTION

A display control device of an embodiment of the invention will be described.

FIG. 1 displays a schematic configuration of a display control device 1.

As shown in FIG. 1, the display control device 1 includes a search database 3, a detailed display database 5, a standard display database 7, an input unit 9, a search unit 11, a display mode determining unit 13, a detailed display data acquisition unit 15, and a display control unit 17.

In this example, the address information is set to specify a wider area by the latter part of the string including the address area name and the address number that constitute the address information. Also, the address information is set to specify a narrower area by the former part of the string. In other words, in the example, the more detailed area is stepwisely specified when the address information is referred to from the latter part to the former part.

The search database 3 stores search data sets for a destination searches. Examples of the search data sets include address search data, facility name search data, telephone number search data, and postal code search data. Each of the data sets (such as an address information, a facility name) is associated with point coordinates. Also, there may be a flag for determining whether the point coordinates associated with the address information or the facility name correspond to coordinates for displaying a position of the address or a position of the facility at a specific point, or other coordinates for displaying an alternative position, which is different from the position of the address or the facility, as a peripheral point of the address or the facility. Alternatively, the facility name may be associated with the address information in the above facility name search data.

The standard display database 7 stores the standard display data sets, which include multiple pairs of the position indication item and the point coordinates associated with the position indication item, together with map data for displaying the map. The later-described display control unit 17 displays the standard display map based on the standard display data. The above stored standard display data may be classified, for example, based on scale factors for displaying the map.

The detailed display database 5 stores detailed display data sets including multiple pairs of the position indication item and the point coordinates associated with the position indication item. The position indication item is a label for indicating a point on the map, and examples of the item include an item for indicating an address (such as “-Chome”, “house number”), an item for indicating the facility name (such as “building name”, “tenant name”) and other items (such as telephone numbers, postal codes). The position indication item may alternatively be a street name, an intersection name, or a traffic signal name.

The input unit 9 receives input of the destination for a destination search. Specifically, in the address search, the term “X, Marunouchi Y-Chome, Naka Ward, Nagoya” may be inputted, and in the facility name search, the term “XX Company Ltd.” may be inputted. The input unit 9 may employ a mouse, a light pen, a pointing device (such as a touch sensitive panel) that works with content of a display, a keyboard, or an audio input device (such as a microphone).

The search unit 11 searches for the destination inputted through the input unit 9 with reference to the above search database 7. Examples of the search method include searching the search database for the inputted destination by suffix search. More specifically, a case is supposed where the address information of “X, Marunouchi Y-Chome, Naka Ward, Nagoya” is inputted as the destination and the search database includes “X, Marunouchi Y-Chome, Naka Ward, Nagoya”. In the above case, the search unit 11 sends data of “X, Marunouchi Y-Chome, Naka Ward, Nagoya” to the later-described display mode determining unit 13 as the search result. Also, in the above example, when the inputted address information of “X, Marunouchi Y-Chome, Naka Ward, Nagoya” does not exist in the search database, the search unit 11 selects the address information that matches the most with the inputted address information when compared from the latter part to the former part, and sends the found address information to the display mode determining unit 13 as the search results. For example, when the search database includes both the address information of “Marunouchi, Naka Ward, Nagoya” and “Marunouchi Y-Chome, Naka Ward, Nagoya”, the search unit 11 sends data of “Marunouchi Y-Chome, Naka Ward, Nagoya” to the display mode determining unit 13 as the search result. In another example, when the flag is set in the above search database 3 to indicate whether the point coordinates, which are associated with the address information or the facility name, correspond to the coordinates for a specific point display or for a peripheral point display, the set flag may be additionally sent to the display mode determining unit 13.

Note that in a case, where the address information is set to specify the wider area by the former part of the string and to specify the narrower area by the latter part of the string, the search unit 11 searches for the address information that matches the most with the inputted address information when compared from the former part to the latter part.

The display mode determining unit 13 refers to the search unit 11, and determines whether the inputted destination, which is the search target, is displayed in the specific point display mode or in the peripheral point display mode. An example of the determination method is described below. When the above inputted address information is “X, Marunouchi Y-Chome, Naka Ward, Nagoya” and the search result is “X, Marunouchi Y-Chome, Naka Ward, Nagoya”, both completely match with each other. In the above case, it is determined that the display mode is the specific point display mode because the inputted address information will be displayed at a specific point in the center of the map based on the point coordinates associated with the search result of “X, Marunouchi Y-Chome, Naka Ward, Nagoya”. In contrast, when the search result is “Marunouchi Y-Chome, Naka Ward, Nagoya” instead, it is determined that the display mode is the peripheral point display mode because the point coordinates associated with the above search result will be displayed as the peripheral point in the center of the map instead of the inputted address information of “X, Marunouchi Y-Chome, Naka Ward, Nagoya”. In another example, when the above flag is set, it is possible to determine the display mode based on the flag. When it is determined that the display mode is the specific point display mode, the display mode determining unit 13 sends, to the display control unit 17, a signal indicating that there is no position indication item to be added to the above standard display map (or in other words, the signal indicating that so-called zero data is added to the standard display map). In contrast, when it is determined that the display mode is the peripheral point display mode, the display mode determining unit 13 sends, to the detailed display data acquisition unit 15, a signal to cause the detailed display data acquisition unit 15 to acquire the position indication item to be added to the above standard display map.

The detailed display data acquisition unit 15 refers to the detailed display database 5 and acquires detailed display data sets as required. Examples of the acquired detailed display data sets include the position indication item having point coordinates around the inputted destination. Examples of methods of acquiring such position indication item include acquiring the position indication item, which has the point coordinates around the search results, based on the point coordinates associated with the search result by the search unit 11.

The display control unit 17 refers to the detailed display data acquisition unit 15 and display, on the standard display map displayed based on the standard display database 7, the above acquired position indication item in association with the point coordinates. The display manner is not limited to any specific way. The positions of the position indication items to be displayed may be adjusted such that the position indication items do not overlap with each other. Alternatively, the items may overlap with each other.

An operation of the display control device 1 illustrated in FIG. 1 will be described with reference to FIG. 2.

Firstly, at step 1, the input unit 9 receives input of the destination. For example, the input unit 9 receives input of the address information of “X, Marunouchi Y-Chome, Naka Ward, Nagoya”.

At step 3, the search unit 11 refers to the search database 3 and searches the search database for the one that matches the most with the address information inputted at step 1. More specifically, when the search database includes “X, Marunouchi Y-Chome, Naka Ward, Nagoya”, the search unit 11 selects the above data as the search result. When the exact match data does not exist, the data of “Marunouchi Y-Chome, Naka Ward, Nagoya” may be selected as the search result for example, because the above data has more likelihood of matching. There will be described below a case, where the data of “Marunouchi Y-Chome, Naka Ward, Nagoya” is acquired as the search result.

At step 5, the display mode determining unit 13 determines whether the destination is displayed in the specific point display mode or in the peripheral point display mode based on the destination inputted at step 1 and the search result at step 3.

At step 7, when the display mode determining unit 13 determines at step 5 that the display mode is the peripheral point display mode (step 7: Yes), control proceeds to step 9. In contrast, if the determination result is No at step 7, control proceeds to step 13.

At step 9, the detailed display data acquisition unit 15 acquires the detailed display data from the detailed display database 5 based on the search result at step 3. Examples of a method acquiring the above data include acquiring the position indication item, which is positioned within a predetermined range from the point coordinates associated with the search result of “Marunouchi Y-Chome, Naka Ward, Nagoya” acquired at the above step 3.

At step 11, the display control unit 17 adds the position indication item acquired at step 9 to the standard display map acquired by referring the standard display database 7, and displays the peripheral display map having the peripheral point thereon. In contrast, at step 13, the display control unit 17 refers to the standard display database 7 and displays the standard display map having the destination thereon.

FIG. 3 illustrates a display control device 21 according to another embodiment. In FIG. 3, components similar to those in FIG. 1 are designated by the same numerals, and the descriptions of the components are partially omitted.

FIG. 3 shows the display control device 21 capable of acquiring the above detailed display data based on an input category of the received destination and displaying the data on the map. In other words, the device 21 further includes an input category specifying unit 23 in addition to the device 1 illustrated in FIG. 1, and includes a detailed display data acquisition unit 25 to replace the detailed display data acquisition unit 15.

The input category specifying unit 23 refers to the input unit 9 and specifies the input category of the inputted destination. The specifying method is not limited to any specific way. When the inputted string includes prefecture names, city names, ward names, and the like, the input category may be specified as the address information. When the inputted string includes “Company Ltd.”, “store”, and the like, the input category may be specified as the facility name.

The detailed display data acquisition unit 25 further refers to the input category specifying unit 23 and acquires, from the detailed display database 5, a position indication item that corresponds to the specified input category.

In the device 21, the display control unit 17 additionally displays the acquired detailed display data on the standard display map based on the associated point coordinates.

FIG. 4 illustrates a display control device 100 according to an embodiment example. In FIG. 4, components similar to those in FIGS. 1 and 3 are designated by the same numerals, and the descriptions of the components are partially omitted.

FIG. 4 illustrates the display control device 100 capable of replacing the position indication item, which is displayed on the map with a category different from the input category, with the position indication item acquired based on the above input category. In other words, the device 100 further includes a control unit 141, a memory unit 142, an output unit 143 and an interface unit 144 in addition to the components of the device 1 illustrated in FIG. 1.

The control unit 141 is a computer device having a CPU, a buffer memory, and other devices and controls other components that constitute the display control device 100. The control unit 141 includes a display control unit 146.

The display control unit 146 replaces the position indication item, which is displayed based on the standard display database 7 with a category different from the specified input category, with the position indication item acquired from the detailed display database 5 based on the specified input category. Examples of the displaying method include first deleting the position indication item displayed in the category different from the specified input category, and then adding the position indication item that corresponds to the input category.

The memory unit 142 stores computer programs, and the computer programs are read by the control unit 141 serving as a computer device such that the programs provide functions. The computer program may be stored in an internal hard disk or an internal memory serving as a storage device of a terminal device or a mobile terminal device. Alternatively, the computer program may be stored in an SD (registered trademark) memory card, a memory stick, a smart media, a compact flash (registered trademark), or a general medium (such as DVD), which serve as a storage medium removable from the terminal device or the mobile terminal device.

The output unit 143 includes a display and displays an input screen, the search results by the search unit 11, the standard display map and the peripheral display map based on the control of the display control unit 146, and other information. The output unit 143 may include an audio output unit.

The interface unit 144 connects the display control device 100 with a wireless network.

The embodiments and the embodiment examples of the present invention have been described as above. Two or more of the embodiments (the embodiment examples) may be combined and implemented. Alternatively, one of the embodiments (the embodiment examples) may be partially implemented. Furthermore, two or more of the embodiments (the embodiment examples) may be partially combined and implemented.

The invention is not limited to the above descriptions of the embodiments and the embodiment examples of the invention. The invention includes various modifications provided that the modifications do not depart from the scope of claims and that the modifications are easily contemplated by those skilled in the art.

### DESCRIPTION OF THE NUMERALS

1, 21, 100 display control device
3 search database
5 detailed display database
7 standard display database
9 input unit
11 search unit
13 display mode determining unit
15, 25 detailed display data acquisition unit
17, 146 display control unit
23 input category specifying unit

1. A display control device for displaying an alternative position different from a position of a destination when the position of the destination is unable to be displayed at a specific point in a center of a map as a result of a destination search, the display control device comprising:
a detailed display database storing a position indication item and point coordinates associated with the position indication item;
a data acquisition unit configured to acquire the position indication item, which is to be displayed on the map, together with the associated point coordinates when the alternative position is displayed; and
a display control unit configured to display the acquired position indication item on the map based on the associated point coordinates.

2. The display control device according to claim 1, wherein:
the data acquisition unit acquires the position indication item based on an input category of the destination in the destination search.

3. The display control device according to claim 2, wherein:
the display control unit replaces the position indication item, which is displayed on the standard display map with the input category different from the input category of the destination, with the acquired position indication item when the alternative position is displayed.

4. A display control method for displaying an alternative position different from a position of a destination when the position of the destination is unable to be displayed at a specific point in a center of a map as a result of a destination search, the method comprising steps of:
acquiring, when the alternative position is displayed, a position indication item, which is to be displayed on the map, together with point coordinates, which are associated with the position indication item, from a detailed display database storing the position indication item and the associated point coordinates; and
displaying the acquired position indication item on the map based on the associated point coordinates.

5. The display control method according to claim 4, wherein:
the acquiring of the position indication item acquires the position indication item based on an input category of the destination in the destination search.

6. The display control method according to claim 5, wherein:
the displaying of the acquired position indication item replaces the position indication item, which is displayed on the standard display map with the input category different from the input category of the destination, with the acquired position indication item when the alternative position is displayed.

7. A tangible non-transitory computer-readable storage medium that contains a computer program for displaying an alternative position different from a position of a destination when the position of the destination is unable to be displayed at a specific point in a center of a map as a result of a destination search, the computer program, when executed by a computer, causing the computer to function as:
data acquiring means for acquiring, when the alternative position is displayed, a position indication item, which is to be displayed on the map, together with point coordinates, which are associated with the position indication item, from a detailed display database storing the position indication item and the associated point coordinates; and
display controlling means for displaying the acquired position indication item on the map based on the associated point coordinates.

8. The storage medium according to claim 7, wherein:
the data acquiring means acquires the position indication item based on an input category of the destination in the destination search.

9. The storage medium according to claim 8, wherein:
the display controlling means replaces the position indication item, which is displayed on the standard display map with the input category different from the input category of the destination, with the acquired position indication item when the alternative position is displayed.
